(19) United States
(12) Patent Application Publication
(10) Pub. No.: US 2025/0087761 A1
(43) Pub. Date: Mar. 13, 2025

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/754,611

(22) Filed: Jun. 26, 2024

(30) Foreign Application Priority Data
Sep. 13, 2023 (JP) 2023-148306

(51) Int. Cl. H01M 10/42; G06K 19/06; H01M 50/107

(52) U.S. Cl. CPC H01M 10/4221; G06K 19/06037; H01M 50/107

(57) ABSTRACT

The power storage cell includes a cell case, a first two-dimensional identification code, and a second two-dimensional identification code. The cell case is configured to be capable of accommodating an electrode body. The first two-dimensional identification code is provided on an outer surface of the cell case. The first two-dimensional identification code is configured to be able to read the identification information. The second two-dimensional identification code is provided on the outer surface of the cell case spaced apart from the first two-dimensional identification code. The second two-dimensional identification code is configured to be able to read the same identification information as the first two-dimensional identification code. The second two-dimensional identification code is provided at a position where at least a part of the first two-dimensional identification code cannot be visually recognized when the second two-dimensional identification code is viewed from the front.

### CROSS-REFERENCE TO RELATED APPLICATION

This application claims priority to Japanese Patent Application No. 2023-148306 filed on Sep. 13, 2023, incorporated herein by reference in its entirety.

### BACKGROUND

### 1. Technical Field

The present disclosure relates to a power storage cell.

### 2. Description of Related Art

Japanese Unexamined Patent Application Publication No. 2011-210663 (JP 2011-210663 A) discloses a cylindrical battery that includes a two-dimensional code that indicates individual identification information and an auxiliary two-dimensional code that indicates the same individual identification information as the two-dimensional code. The two-dimensional code is in a specific region on a battery side surface having a first distance from the battery bottom portion and having a second distance from the battery head portion. The auxiliary two-dimensional code is at a position having a third distance from the two-dimensional code in the specific region.

### SUMMARY

In the cylindrical battery described in JP 2011-210663 A, the two two-dimensional codes are arranged so as to be relatively close in distance within the specific region. The relatively close distance between the two two-dimensional codes tends to cause a situation in which both the two-dimensional codes cannot be read.

For example, in a state in which the power storage cell is mounted on a module, there easily occurs a situation in which one of the two-dimensional codes is not exposed to the outside of the module and the other two-dimensional code is also not exposed to the outside. Further, when a module on which the power storage cell is mounted is disassembled or the like, there easily occurs a situation in which one of the two-dimensional codes is damaged in the power storage cell and the other two-dimensional code is also damaged.

The present disclosure has been made in view of the above issue, and an object of the present disclosure is to provide a power storage cell that facilitates reading of identification information from two-dimensional identification codes regardless of the state of the power storage cell.

An aspect of the present disclosure provides a power storage cell including a cell case, a first two-dimensional identification code, and a second two-dimensional identification code. The cell case is configured to be capable of accommodating an electrode body. The first two-dimensional identification code is provided on an outer surface of the cell case. The first two-dimensional identification code is configured to enable reading of identification information. The second two-dimensional identification code is provided on the outer surface of the cell case separately from the first two-dimensional identification code. The second two-dimensional identification code is configured to enable reading of the same identification information as the first two-dimensional identification code. The second two-dimensional identification code is provided at a position that does not allow visually recognizing at least a part of the first two-dimensional identification code when the second two-dimensional identification code is seen from front.

According to the above configuration, the identification information can be read from the second two-dimensional identification code even in a direction in which the identification information cannot be read from the first two-dimensional identification code. As a result, the identification information can be easily read from the two-dimensional identification codes regardless of the state of the power storage cell.

For example, in a state in which the power storage cell is mounted on a module, the second two-dimensional identification code may be exposed to the outside of the module even if the first two-dimensional identification code is not exposed to the outside of the module. Therefore, it is possible to easily read the identification information from the two-dimensional identification codes. Meanwhile, when a module on which the power storage cell is mounted is disassembled or the like, the second two-dimensional identification code may avoid being damaged even when the power storage cell is damaged on the front side with the first two-dimensional identification code. Therefore, it is possible to easily read the identification information from the two-dimensional identification codes regardless of the state of the power storage cell.

According to the present disclosure, it is possible to easily read the identification information from the two-dimensional identification codes regardless of the state of the power storage cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a power storage cell according to a first embodiment from above;

FIG. 2 is a perspective view illustrating a power storage cell according to the first embodiment from below;

FIG. 3A is a diagram illustrating a power storage cell when a first two-dimensional identification code is viewed from the front;

FIG. 3B is a schematic diagram illustrating a power storage cell when a second two-dimensional identification code is viewed from the front;

FIG. 4 is a perspective view illustrating a power storage cell according to a modification of the first embodiment from below;

FIG. 5 is a perspective view showing a power storage cell according to Embodiment 2; and

FIG. 6 is a perspective view illustrating a power storage cell according to a third embodiment.

### DETAILED DESCRIPTION OF EMBODIMENTS

Hereinafter, a power storage cell according to each embodiment of the present disclosure will be described with reference to the drawings. The same or corresponding parts in the drawings are denoted by the same reference numerals, and the description thereof will not be repeated.

### First Embodiment

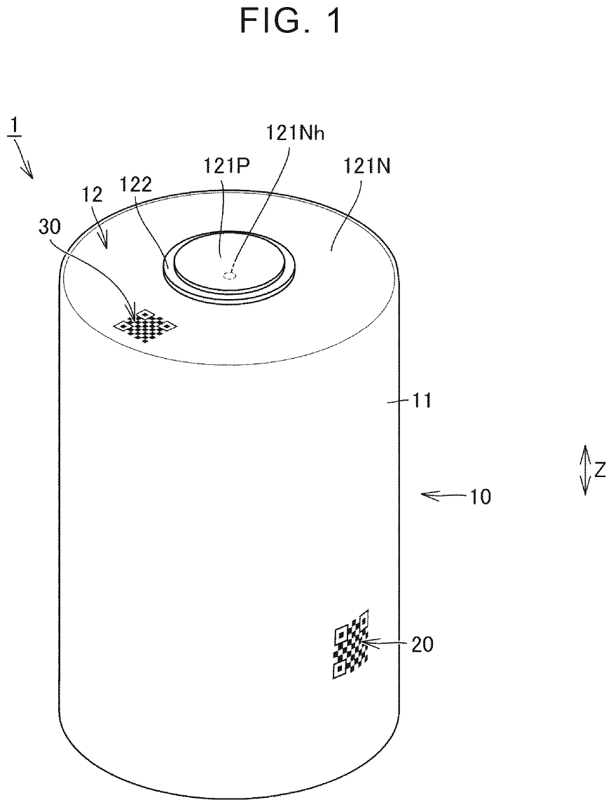

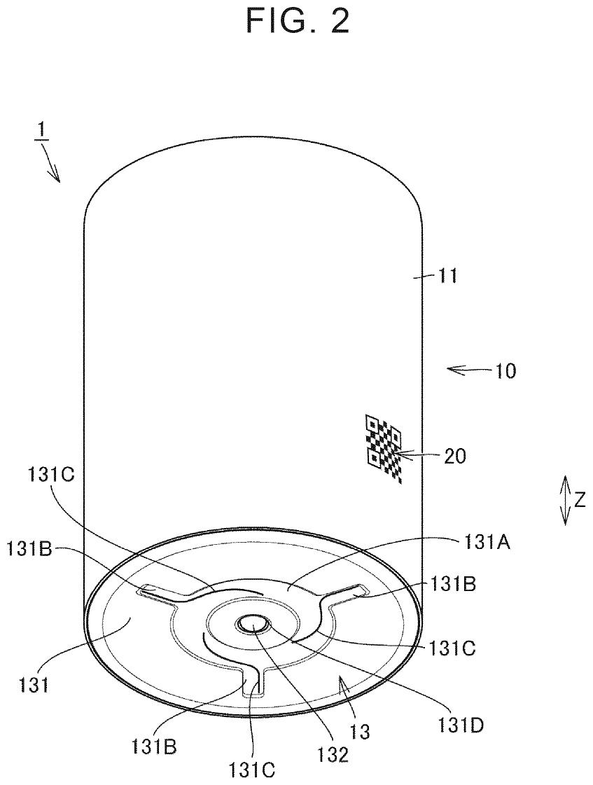

FIG. 1 is a perspective view illustrating a power storage cell according to a first embodiment from above. FIG. 2 is a perspective view illustrating a power storage cell according to the first embodiment from below.

As shown in FIGS. 1 and 2, the power storage cell 1 according to the first embodiment of the present disclosure is a so-called cylindrical battery. The power storage cell 1 includes a cell case 10, a first two-dimensional identification code 20, and a second two-dimensional identification code 30.

The cell case 10 is configured to accommodate an electrode body. In the present embodiment, the cell case 10 houses an electrode assembly (not shown). The electrode assembly includes an electrode plate group in which a positive electrode and a negative electrode are wound with a separator interposed therebetween. The cell case 10 further contains an electrolytic solution (not shown).

The cell case 10 includes an outer peripheral wall portion 11, a top surface portion 12, and a bottom surface portion 13. The outer peripheral wall portion 11 has a cylindrical outer shape. The material constituting the outer peripheral wall portion 11 is not particularly limited, but is made of a conductive material such as aluminum, copper, or stainless steel.

The top surface portion 12 closes one end of the outer peripheral wall portion 11. The top surface portion 12 is located on one side of the electrode body accommodated in the cell case 10 in the axial direction Z of the cylindrical outer peripheral wall portion 11.

The top surface portion 12 includes a top surface main body portion 121N, an external terminal 121P, and an insulating member 122.

The top body portion 121N has a plate-like outer shape. The top body portion 121N has a circular outer shape when viewed from the axial direction Z. The peripheral edge of the top body portion 121N is connected to the outer peripheral wall portion 11. In the present embodiment, the outer peripheral wall portion 11 and the top surface main body portion 121N are integrally formed as a single member. The outer peripheral wall portion 11 and the top surface main body portion 121N may be formed of separate members. Here, the outer peripheral wall portion 11 and the top surface main body portion 121N may be joined to each other by welding such as laser-welding. A through-hole 121Nh penetrating in the axial direction Z is formed substantially in the center of the top surface main body portion 121N. The top body 121N may be made of aluminum, copper, stainless steel, or the like.

The external terminal 121P has a circular outer shape when viewed from the axial direction Z. The external terminal 121P is located at the most end of the cell case 10 in one direction in the axial direction Z. The external terminal 121P is located outward of the top surface main body portion 121N in the axial direction Z. The external terminal 121P is positioned so as to cover the through-hole of the cover top surface main body portion 121N. The external terminal 121P is electrically connected to one of the positive electrode and the negative electrode of the electrode assembly accommodated in the cell case 10 via the through-hole 121Nh. Specifically, the external terminal 121P is electrically connected to the positive electrode of the cell case 10 through the through-hole 121Nh. The external terminal 121P is a positive terminal. At this time, the cell case 10 may further include a positive electrode current collector plate. The external terminal 121P and the positive electrode of the electrode assembly may be electrically connected to each other via the positive electrode current collector plate. The external terminal 121P is made of aluminum, copper, stainless steel, or the like.

In the insulating member 122, the insulating member 122 insulates the top surface main body portion 121N from the external terminal 121P. The insulating member 122 is disposed between the top main body portion 121N and the external terminal 121P.

The bottom surface portion 13 closes the other end of the outer peripheral wall portion 11. The bottom surface portion 13 is located on the other side of the electrode body accommodated in the cell case 10 in the axial direction Z.

The bottom surface portion 13 includes a bottom surface main body portion 131 and a sealing plug 132. The bottom surface main body portion 131 has a plate-like outer shape. The bottom surface main body portion 131 has a circular outer shape when viewed in the axial direction. A peripheral edge of the bottom surface main body portion 131 is connected to the outer peripheral wall portion 11. The bottom surface main body portion 131 is joined to the peripheral edge of the outer peripheral wall portion 11 by welding such as 30 laser welding. The bottom surface main body portion 131 may be fixedly connected to the outer peripheral wall portion 11 by caulking the outer peripheral wall portion 11. When the top surface main body portion 121N and the outer peripheral wall portion 11 are formed of different members, the outer peripheral wall portion 11 and the bottom surface main body portion 131 may be integrally formed as a single member. The material constituting the bottom surface main body portion 131 is not particularly limited, but is made of a conductive material such as aluminum, copper, or stainless steel.

The bottom surface main body portion 131 is directly bonded to the positive electrode or the negative electrode of the electrode body in the cell case 10 by welding from the outside of the cell case 10. Specifically, the bottom surface main body portion 131 is bonded to the negative electrode. As a result, the bottom surface main body portion 131 is negatively charged. The bottom surface main body portion 131 may function as a negative terminal. The outer peripheral wall portion 11 joined to the bottom surface main body portion 131 is also negatively charged. The top surface main body 121N formed integrally with the outer peripheral wall portion 11 is also negatively charged. Therefore, the top body portion 121N may be connected to another power storage cell or the like as the negative electrode terminal.

The bottom surface main body portion 131 has a ring-shaped ridge portion 131A, a plurality of radial ridge portions 131B, a plurality of weld portions 131C, and a through-hole 131D. The annular ridge 131A extends in an annular shape when viewed from the axial direction Z. The annular ridge portion 131A protrudes toward the inside of the cell case 10. The ring-shaped ridge portion 131A is in contact with the negative electrode of the electrode assembly.

The plurality of radial ridge portions 131B extend in a radial direction centered on the center of the bottom surface portion 13 when viewed in the axial direction. The plurality of radial ridge portions 131B are spaced apart from each other. The plurality of radial ridge portions 131B are arranged at equal intervals in the circumferential direction. The plurality of radial ridge portions 131B are continuous with the ring-shaped ridge portion 131A. The plurality of radial ridge portions 131B protrude toward the inside of the cell case 10. The plurality of radial ridge portions 131B are in contact with the negative electrode of the electrode assembly.

The plurality of weld portions 131C are portions of the bottom surface main body portion 131 that are joined to the negative electrode of the electrode assembly in the cell case 10 by welding. The plurality of weld portions 131C are formed by laser-welding from the outer side of the cell case 10. The plurality of weld portions 131C are formed in the ring-shaped ridge portion 131A. In the ring-shaped ridge portion 131A, the plurality of weld portions 131C are formed so as to extend along the circumferential direction when the center of the bottom surface portion 13 is viewed from the axial direction Z as a center. The plurality of weld portions 131C are formed in each of the plurality of radial ridge portions 131B. In the radial ridge portion 131B, the weld portion 131C is formed so as to extend along the radial direction. The annular ridge 131A and the plurality of radial ridges 131B may be thinner than other parts of the bottom surface main body portion 131. Thus, the welded portion 131C can be easily formed.

The through-hole 131D is formed in the center of the bottom surface main body portion 131 when viewed from the axial direction Z. The through-hole 131D may be used to inject the electrolyte contained in the cell case 10.

The sealing plug 132 is inserted through the through-hole 131D of the bottom surface main body portion 131. As a result, the sealing plug 132 is fixed to the bottom surface main body portion 131. The through-hole 131D and the sealing plug 132 may function as a pressure release valve for releasing the pressure inside the cell case 10 when the pressure becomes excessively high inside the cell case 10.

The first two-dimensional identification code 20 is configured to be able to read identification information by a predetermined reader. The identification information includes, for example, individual identification information of the power storage cell 1 provided with the first two-dimensional identification code 20. Individual identification information includes, for example, manufacturing date, manufacturing time, manufacturing line, and lot number of the power storage cell 1. The first two-dimensional identification code 20 is, for example, a QR code (registered trademark).

The first two-dimensional identification code 20 is provided on the outer surface of the cell case 10. The first two-dimensional identification code 20 may be printed directly on the outer surface of the cell case 10 by ink or the like, or a label on which the first two-dimensional identification code 20 is printed in advance may be attached to the outer surface of the cell case 10. The first two-dimensional identification code 20 may be engraved on the cell case 10 by a laser or the like. In the present embodiment, the first two-dimensional identification code 20 is provided on the outer peripheral wall portion 11.

The second two-dimensional identification code 30 is configured to be able to read the same identification information as the first two-dimensional identification code 20. In the second two-dimensional identification code 30, at least part of the identification information to be read may be the same as the identification information to be read by the first two-dimensional identification code 20. The second two-dimensional identification code 30 is, for example, a QR code (registered trademark). The second two-dimensional identification code 30 is preferably the same as the first two-dimensional identification code 20.

The second two-dimensional identification code 30 is separated from the first two-dimensional identification code 20. The second two-dimensional identification code 30 is provided on the outer surface of the cell case 10. The second two-dimensional identification code 30 may be printed directly on the outer surface of the cell case 10 by ink or the like, or a label on which the second two-dimensional identification code 30 is printed in advance may be attached to the outer surface of the cell case 10. The second two-dimensional identification code 30 may be engraved on the cell case 10 by a laser or the like.

In the present embodiment, the second two-dimensional identification code 30 is provided on the top surface portion 12. Specifically, the second two-dimensional identification code 30 is provided on the top surface main body portion 121N.

The position of the first two-dimensional identification code 20 and the position of the second two-dimensional identification code 30 may be opposite to each other. That is, the first two-dimensional identification code 20 may be provided on the top surface portion 12, and the second two-dimensional identification code 30 may be provided on the outer peripheral wall portion 11.

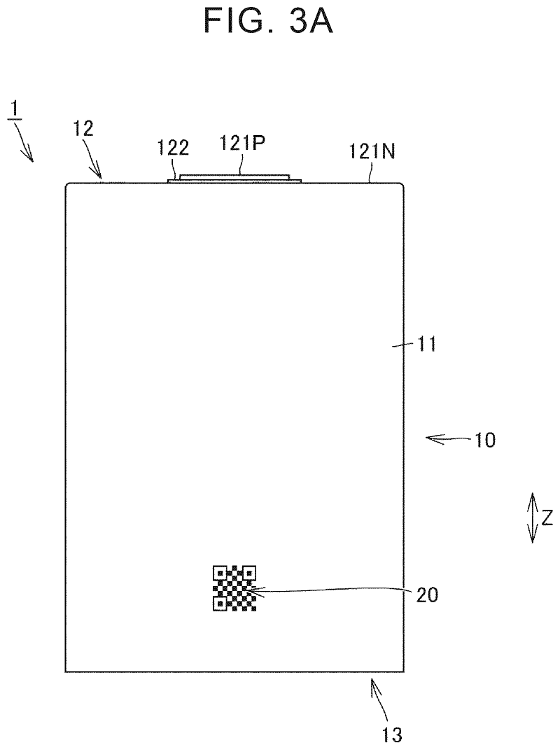

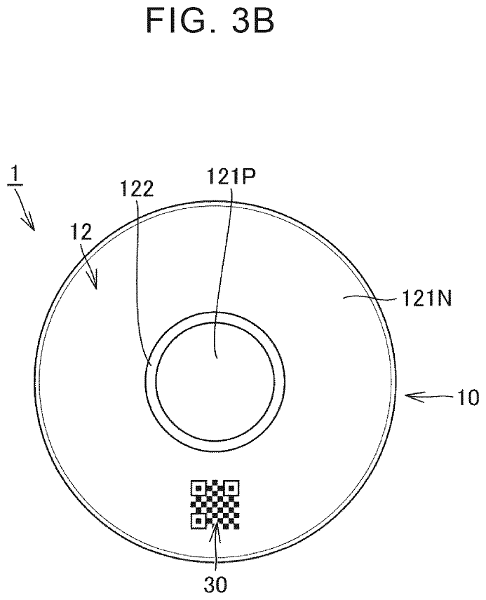

FIG. 3A is a diagram illustrating a power storage cell when the first two-dimensional identification code is viewed from the front. As shown in FIG. 3A, the first two-dimensional identification code 20 is provided at a position where at least a part of the second two-dimensional identification code 30 cannot be visually recognized when the first two-dimensional identification code 20 is viewed from the front. Specifically, the first two-dimensional identification code 20 is provided at a position such that the entire second two-dimensional identification code 30 is not visually recognized when the first two-dimensional identification code 20 is viewed from the front. This is because the top surface main body portion 121N extends in a plane direction perpendicular to the axial direction Z of the outer peripheral wall portion 11.

In the present specification, the front surface of the two-dimensional identification code is a position on a certain virtual straight line. The virtual straight line is a normal line drawn in a central portion of a region of the outer surface of the cell case 10 where the two-dimensional identification code is provided.

FIG. 3B is a diagram illustrating a power storage cell when the second two-dimensional identification code is viewed from the front. As shown in FIG. 3B, the second two-dimensional identification code 30 is provided at a position where at least a part of the first two-dimensional identification code 20 cannot be visually recognized when the second two-dimensional identification code 30 is viewed from the front. Specifically, the second two-dimensional identification code 30 is provided at a position such that the entire first two-dimensional identification code 20 is not visually recognized when the second two-dimensional identification code 30 is viewed from the front. This is because the outer peripheral surface of the outer peripheral wall portion 11 extends in a direction perpendicular to the plane direction in which the top surface main body portion 121N extends.

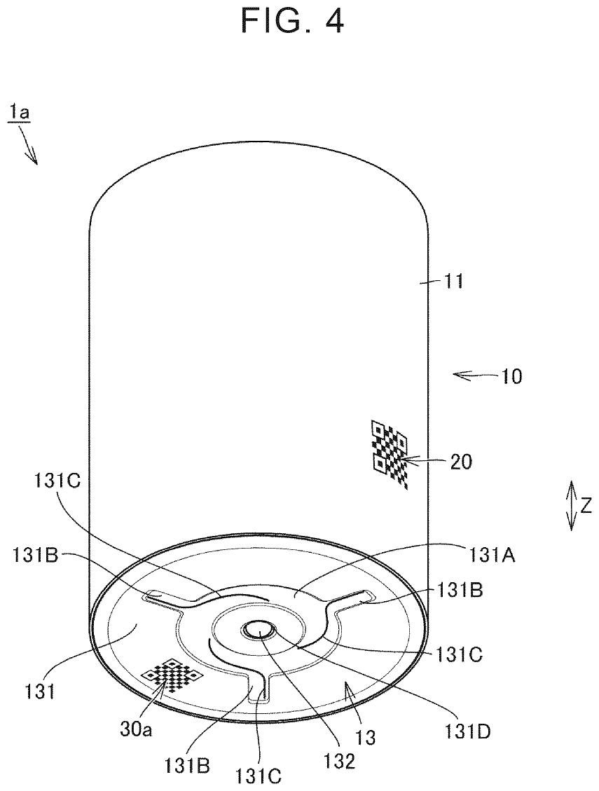

The second two-dimensional identification code 30 may be provided on the bottom surface portion 13. FIG. 4 is a perspective view illustrating a power storage cell according to a modification of the first embodiment from below. As illustrated in FIG. 4, in the power storage cell 1a according to the modification of the first embodiment, the second two-dimensional identification code 30a is provided on the bottom surface portion 13. Specifically, the second two-dimensional identification code 30a is provided in the bottom surface main body portion 131. Also in this modification, the position of the first two-dimensional identification code 20 and the position of the second two-dimensional identification code 30a may be opposite to each other. That is, the second two-dimensional identification code 30a may be provided on the outer peripheral wall portion 11, and the first two-dimensional identification code 20 may be provided on the bottom surface portion 13.

Also in the present modification, the first two-dimensional identification code 20 is provided at a position where at least a part of the second two-dimensional identification code 30a cannot be visually recognized when the first two-dimensional identification code 20 is viewed from the front. The second two-dimensional identification code 30a is provided at a position where at least a part of the first two-dimensional identification code 20 cannot be visually recognized when the second two-dimensional identification code 30a is viewed from the front.

Further, the power storage cell 1 may include three or more two-dimensional identification codes. For example, the third two-dimensional identification code may be arranged at a position where the first two-dimensional identification code 20 and the second two-dimensional identification code 30 can be arranged in the present embodiment and the above-described modification.

As described above, the power storage cell 1 according to the first embodiment of the present disclosure includes the cell case 10, the first two-dimensional identification code 20, and the second two-dimensional identification code 30. The cell case 10 is configured to accommodate an electrode body. The first two-dimensional identification code 20 is provided on the outer surface of the cell case 10. The first two-dimensional identification code 20 is configured to be able to read the identification information. The second two-dimensional identification code 30 is provided on the outer surface of the cell case 10 so as to be separated from the first two-dimensional identification code 20. The second two-dimensional identification code 30 is configured to be able to read the same identification information as the first two-dimensional identification code 20. The second two-dimensional identification code 30 is provided at a position where at least a part of the first two-dimensional identification code 20 cannot be visually recognized when the second two-dimensional identification code 30 is viewed from the front.

According to the above configuration, the identification information can be read from the second two-dimensional identification code 30 even in a direction in which the identification information cannot be read from the first two-dimensional identification code 20. As a result, the identification information can be easily read from the two-dimensional identification code regardless of the state of the power storage cell 1.

For example, in a state in which the power storage cell 1 is mounted on the module, the second two-dimensional identification code 30 may be exposed to the outside of the module even if the first two-dimensional identification code 20 is not exposed to the outside of the module. Therefore, it is possible to easily read the identification information from the two-dimensional identification code. In addition, the second two-dimensional identification code 30 can avoid damage even when the power storage cell 1 is damaged on the front side of the first two-dimensional identification code 20, for example, when the module on which the power storage cell 1 is mounted is disassembled. Therefore, it is possible to easily read the identification information from the two-dimensional identification code regardless of the state of the power storage cell 1.

Further, in the first embodiment of the present disclosure, the cell case 10 includes an outer peripheral wall portion 11, a top surface portion 12, and a bottom surface portion 13. The outer peripheral wall portion 11 has a cylindrical shape. The top surface portion 12 closes one end of the outer peripheral wall portion 11. The bottom surface portion 13 closes the other end of the outer peripheral wall portion 11. One of the first two-dimensional identification code 20 and the second two-dimensional identification code 30 is provided on the outer peripheral wall portion 11. The other of the first two-dimensional identification code 20 and the second two-dimensional identification code 30 is provided on the top surface portion 12 or the bottom surface portion 13.

According to the above configuration, even if the power storage cell 1 has a so-called cylindrical shape, it is easy to read the identification information from the two-dimensional identification code regardless of the state of the power storage cell 1.

For example, in a state before the power storage cell 1 is incorporated in the module, the identification information can be read from the two-dimensional identification code on the outer peripheral wall portion 11. On the other hand, in some cases, a plurality of power storage cells 1 are incorporated in the module, and the outer peripheral wall portions 11 of the power storage cells 1 are arranged so as to face each other. In this case, the identification information can be read from the two-dimensional identification code on the top surface portion 12 or the bottom surface portion 13. Therefore, even if the power storage cell has a so-called cylindrical shape, the identification information can be easily read from the two-dimensional identification code regardless of the state of the power storage cell 1.

### Second Embodiment

Hereinafter, a power storage cell according to a second embodiment of the present disclosure will be described. In the second embodiment of the present disclosure, the position of the first two-dimensional identification code is different from that of the first embodiment. The same configuration and effects as those of the first embodiment will not be described again.

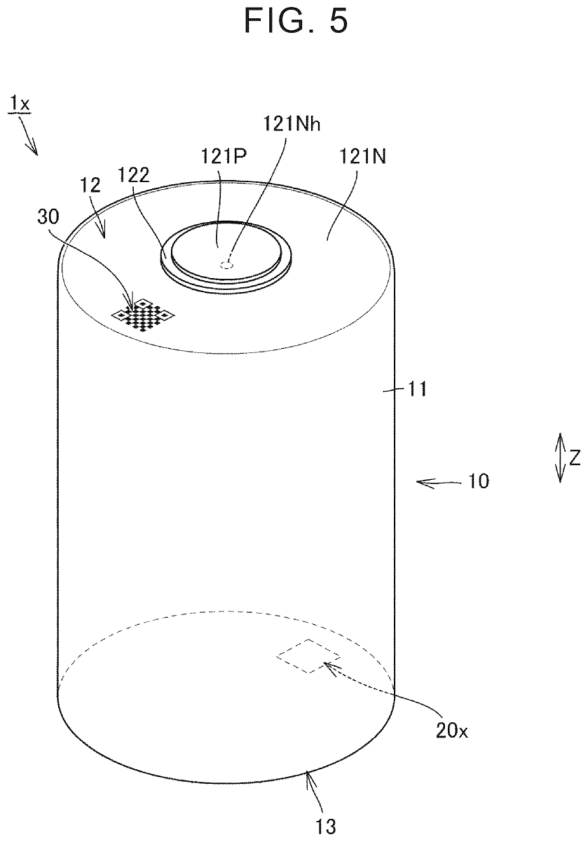

FIG. 5 is a perspective view illustrating a power storage cell according to a second embodiment. As illustrated in FIG. 5, in the power storage cell 1x according to the second embodiment, one of the first two-dimensional identification code 20x and the second two-dimensional identification code 30 is provided on the top surface portion 12. The other of the first two-dimensional identification code 20x and the second two-dimensional identification code 30 is provided on the bottom surface portion 13.

According to the above configuration, even if the power storage cell 1x has a so-called cylindrical shape, the identification information can be easily read from the two-dimensional identification code regardless of the state of the power storage cell 1x.

For example, when one of the top surface main body portion 121N of the top surface portion 12 and the bottom surface main body portion 131 of the bottom surface portion 13 is connected to a busbar or the like as a negative electrode terminal, the identification information can be read from the two-dimensional identification code provided on the other of these terminals. Therefore, even if the power storage cell has a so-called cylindrical shape, it is easy to read the identification information from the two-dimensional identification code.

In the present embodiment, specifically, the first two-dimensional identification code 20x is provided on the bottom surface portion 13, and the second two-dimensional identification code 30 is provided on the top surface portion 12. The position of the first two-dimensional identification code 20x and the position of the second two-dimensional identification code 30 may be opposite to each other. That is, the first two-dimensional identification code 20x may be provided on the top surface portion 12, and the second two-dimensional identification code 30 may be provided on the bottom surface portion 13.

The first two-dimensional identification code 20x and the second two-dimensional identification code 30 are not aligned in the axial direction Z. The first two-dimensional identification code 20x and the second two-dimensional identification code 30 may be arranged in the axial direction Z.

### Embodiment 3

Hereinafter, a power storage cell according to a third embodiment of the present disclosure will be described. In the third embodiment of the present disclosure, the position of the second two-dimensional identification code is different from that of the first embodiment. The same configuration and effects as those of the first embodiment will not be described again.

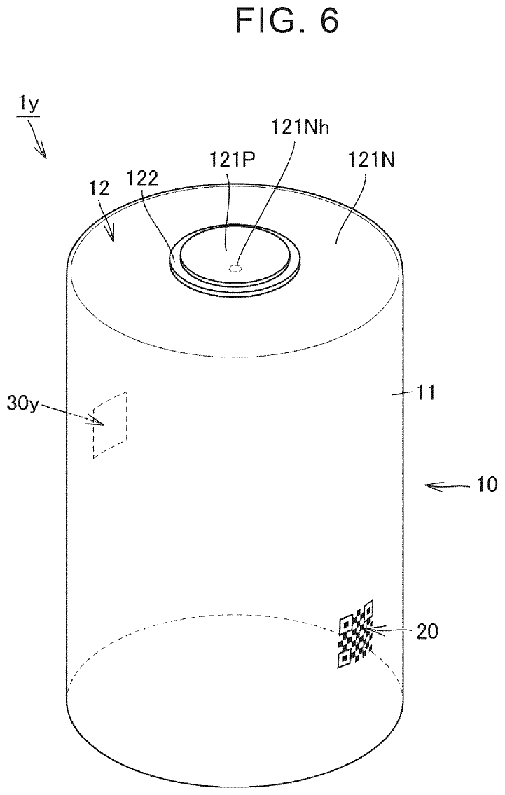

FIG. 6 is a perspective view illustrating a power storage cell according to a third embodiment. As illustrated in FIG. 6, in the power storage cell 1y according to the third embodiment, the first two-dimensional identification code 20 is provided on the outer peripheral wall portion 11. The second two-dimensional identification code 30y is provided on the outer peripheral wall portion 11 such that the first two-dimensional identification code 20 faces away from the facing direction.

According to the above configuration, even if the power storage cell 1y has a so-called cylindrical shape, the identification information can be easily read from the two-dimensional identification code regardless of the state of the power storage cell 1y.

For example, even when the power storage cell 1y is damaged on the front side of the first two-dimensional identification code 20, the second two-dimensional identification code 30y facing away from the direction in which the first two-dimensional identification code 20 is directed is likely to avoid damages. Therefore, it is possible to easily read the identification data from the two-dimensional identification code regardless of the condition of the power storage cell 1y.

In the present embodiment, the first two-dimensional identification code 20 and the second two-dimensional identification code 30y are not aligned in the virtual plane direction perpendicular to the axial direction Z. The first two-dimensional identification code 20 and the second two-dimensional identification code 30y may be arranged in a virtual plane direction perpendicular to the axial direction Z.

In the description of the above-described embodiments, combinable configurations may be combined with each other.

The embodiment disclosed this time should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. A power storage cell comprising:
a cell case configured to be capable of accommodating an electrode body;
a first two-dimensional identification code provided on an outer surface of the cell case and configured to enable reading of identification information; and
a second two-dimensional identification code provided on the outer surface of the cell case separately from the first two-dimensional identification code and configured to enable reading of the same identification information as the first two-dimensional identification code, wherein the second two-dimensional identification code is provided at a position that does not allow visually recognizing at least a part of the first two-dimensional identification code when the second two-dimensional identification code is seen from front.

2. The power storage cell according to claim 1, wherein:
the cell case includes
a cylindrical outer peripheral wall portion,
a top surface portion that closes one end of the outer peripheral wall portion, and
a bottom surface portion that closes another end of the outer peripheral wall portion;
one of the first two-dimensional identification code and the second two-dimensional identification code is provided on the outer peripheral wall portion; and
another of the first two-dimensional identification code and the second two-dimensional identification code is provided on the top surface portion or the bottom surface portion.

3. The power storage cell according to claim 1, wherein:
the cell case includes
a cylindrical outer peripheral wall portion,
a top surface portion that closes one end of the outer peripheral wall portion, and
a bottom surface portion that closes another end of the outer peripheral wall portion;
one of the first two-dimensional identification code and the second two-dimensional identification code is provided on the top surface portion; and
another of the first two-dimensional identification code and the second two-dimensional identification code is provided on the bottom surface portion.

4. The power storage cell according to claim 1, wherein:
the cell case includes
a cylindrical outer peripheral wall portion,
a top surface portion that closes one end of the outer peripheral wall portion, and
a bottom surface portion that closes another end of the outer peripheral wall portion;
the first two-dimensional identification code is provided on the outer peripheral wall portion; and
the second two-dimensional identification code is provided on the outer peripheral wall portion so as to face in a direction opposite to a direction in which the first two-dimensional identification code faces.
